(19) United States
(12) Patent Application Publication
(10) Pub. No.: US 2025/0338942 A1
(43) Pub. Date: Nov. 6, 2025

(54) FUNCTIONAL ARTIFICIAL FINGERNAIL APPARATUS AND METHOD

(71) Applicant: George A. Spurling, III, Winter Garden, FL (US)

(72) Inventor: George A. Spurling, III, Winter Garden, FL (US)

(21) Appl. No.: 19/270,037

(22) Filed: Jul. 15, 2025

Related U.S. Application Data
(63) Continuation of application No. PCT/US24/11559, filed on Jan. 15, 2024.
(60) Provisional application No. 63/439,124, filed on Jan. 15, 2023.

(51) Int. Cl. A45D 31/00; G06F 1/16; G06F 3/01; G06F 3/0354; G06F 3/0488; G06F 3/16; H04W 4/029

(52) U.S. Cl. CPC A45D 31/00; G06F 1/1686; G06F 1/1688; G06F 3/016; G06F 3/03545; G06F 3/0488; G06F 3/16; H04W 4/029; A45D 2200/207

(57) ABSTRACT

A functional artificial fingernail having a terminal member located on a distal tip of the artificial fingernail for operatively interacting with a touch screen. The terminal member may be a passive or active stylus for operatively interacting with a touch screen. The artificial fingernail may also comprise an electronic display to which desired images, colors, patterns, symbols and other graphic elements may be downloaded for display on the fingernail of the user. A processor may control the electronic display, a geolocation receiver, a microphone, a speaker, and a haptic device, allowing geolocation of a user, and allowing audio and mechanical vibration output to the user. The artificial fingernail provides a substantial improvement in data entry via a touchscreen over the use of a stylus pen, reduces or eliminates hazardous waste by reducing use of fingernail paints and fingernail paint removers.

### CROSS REFERENCE TO RELATED APPLICATIONS AND INCORPORATION BY REFERENCE

This Nonprovisional Patent Application is a continuation of, and claims benefit of priority to, International Application PCT/US24/11559, entitled FUNCTIONAL ARTIFICIAL FINGERNAIL APPARATUS AND METHOD, filed under the Patent Cooperation Treaty (PCT) in the United States Receiving Office (USRO) on Jan. 15, 2024; PCT/US24/11559 claims benefit of priority to U.S. Provisional Application No. 63/439,124 filed in the United States Patent and Trademark Office (USPTO) on Jan. 15, 2023, entitled FUNCTIONAL ARTIFICIAL FINGERNAIL APPARATUS AND METHOD, the entire disclosure of each of the foregoing are incorporated by reference herein in their entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### Field of the Invention

The field of the invention relates generally to devices and methods for artificial fingernails. More specifically, in embodiments, the invention is directed to artificial finger nails that allow for the use of all ten fingers of two hands to be used for typing; enable electronic display of decorative and other patterns on the fingernails such that the patterns may be changed electronically, without the use of fingernail paint or polish; may include GPS or other geographic location tracing functionality; provide protecting structure to the fingernail so as to reduce the possibility of fingernail rips or tears; and other features and functions as set forth herein. By using the artificial fingernails of the invention, workflow is improved, especially in the case of keyboard and touchscreen data input activities that require the use of fingers or fingernails to activate mechanical or electronic keypads or keyboard keys. The use of the artificial fingernails of the invention eliminates or dramatically reduces costs of fingernail maintenance and use of environmentally damaging chemicals, as stylist visits and use of fingernail paints and removers would no longer be necessary.

### Background Art

In the background art, artificial fingernails are simple, passive devices that consist of acrylic plastic, shaped to fit snugly onto the fingernail of a user. They are typically attached to the outer surface of the user's natural fingernail by chemical adhesive. Artificial nails of the background art must be replaced periodically, for example monthly. They typically must be painted by hand, or decorated by applique, to meet the decorative desires of the user. They are shaped in such a way as to be decorative, especially in relation to the length of the nail. At the same time, this shaping may inhibit the use of the user's fingers to perform keyboard and touchscreen data input activities that require the use of fingers or fingernails to activate mechanical or electronic keypads or keyboard keys, because the nails themselves are not adapted to withstand the impact of mechanical or electronic keypads or keyboard keys. This means that user must awkwardly position their fingers when typing such that either the tips of the artificial nails or the pads of their fingers impact mechanical or electronic keypads or keyboard keys when typing, leading to data entry errors and reduced data entry efficiency.

In addition, the artificial nails of the prior art requiring repeated periodic replacement and maintenance, meaning that the user is subject to repeated costs. For example, the artificial nails of the prior art may require replacement monthly, or more or less frequently, and usually requiring decorative painting that is replaced bi-monthly or monthly as well, because the painting may chip or crack through normal use, wear and tear.

Still further, fingernail polish, polish remover, paint and other fingernail care products of the current art utilize chemicals and compounds that are harmful to the natural environment. Because the maintenance of natural fingernails and artificial nails generally occurs periodically such as, for example, monthly or even more frequently, a large amount of these chemicals are flushed into the natural environment where they case long term harm to the ecosystem.

What is needed in the art is an apparatus and method that provides features for improved use with mechanical or electronic keypads or keyboard keys, reduces or eliminates the need for periodic maintenance, replacement and/or decorating, and improves artificial fingernail resistance to ripping and other damage resulting from normal use, wear and tear. Furthermore, what is needed in the art is an apparatus and method that allows for the decorating of fingernails and toenails without using environmentally destructive chemicals that eventually are dumped into the natural environment, and that provide data interconnectivity with remote computing and electronic devices, and is operable as a communication and, in embodiments, biometric sensing and feedback device.

### BRIEF SUMMARY OF THE INVENTION

The present invention comprises an apparatus and method that have one or more of the following features and/or steps, which alone or in any combination may comprise patentable subject matter.

In embodiments, the invention is an artificial fingernail, shaped and adapted to be attached to the fingernail of a user, said artificial fingernail comprising a length; a concave shaped inner surface for attaching to a user's fingernail, or to a finger cot; a length that may, in embodiments, extend from a cuticle apex of a user to a distal tip of the artificial fingernail; the artificial fingernail further comprising an optional terminal member attached to the distal tip, the optional terminal member disposed on said distal tip, and extending beyond the distal tip in a direction away from the user's cuticle apex, such that, when the user's finger is engaged in typing on a keyboard, keypad, touchscreen, or other data input device, the terminal member is the primary point of contact of the artificial fingernail with the keyboard, keypad, touchscreen or other input device.

In embodiments, the artificial fingernail may comprise one or more of the following materials: acrylic, graphite, and rubber, in any combination. The artificial fingernail may be, but is not necessarily, flexible to absorb shock when using the artificial fingernail for data entry into a touchscreen or keyboard, and to lengthen the life of the artificial fingernail by improving resistance to cracks and tears such as experienced with traditional artificial fingernails or natural fingernails. In embodiments, the terminal tip may comprise one or more of the following materials: acrylic, graphite, and rubber.

In embodiments, the terminal tip may comprise a stylus for interacting with an electronic touch screen, which stylus may be a resistive stylus, a passive capacitive stylus, an echo stylus or an active stylus.

In embodiments, the artificial fingernail may comprise a finger cot adapted to be retained in a compression fit on the distal end of a finger of a user, wherein the artificial fingernail is attached to the finger cot such that said artificial fingernail is located opposite the fingernail of the user, with a wall of the finger cot disposed between the concave shaped inner surface of the artificial fingernail, and the outer surface of a fingernail of the user.

In embodiments, the artificial fingernail may comprise an electronic display.

In embodiments, the artificial fingernail may further comprise a processor, a non-transitory memory and a wireless interface, wherein the processor is in communication with the electronic display, the memory and the wireless interface, and the non-transitory memory may comprise non-transitory computer readable and executable instructions for commanding the electronic display to emit light energy in a desired image, pattern, or color, or combination of image, pattern, or color as commanded by said processor.

In embodiments, the artificial fingernail may further comprise a geolocation receiver, such as a Global Positioning System (GPS) receiver in communication with the processor, and the non-transitory memory may comprise non-transitory computer readable and executable instructions commanding the processor to read geolocation information from the geolocation receiver and store the geolocation information in memory.

In embodiments, the artificial fingernail may further comprise a microphone in communication with the processor and the non-transitory memory may comprise non-transitory computer readable and executable instructions commanding the processor to receive audio signals information from the microphone and store the audio information in memory.

In embodiments, the artificial fingernail may further comprise a camera in communication with the processor, and the memory may comprise non-transitory computer readable and executable instructions commanding the processor to read photographic image and/or video signals and information from the camera and store the photographic image and/or signals and information in memory.

In embodiments, the artificial fingernail may further comprise a haptic device for outputting tactile (mechanical vibration) energy in communication with the processor wherein the non-transitory memory may comprise non-transitory computer readable and executable instructions commanding the processor to activate the haptic device to output mechanical vibration energy.

In embodiments, the artificial fingernail may further comprise a speaker in communication with the processor wherein the non-transitory memory may comprise non-transitory computer readable and executable instructions commanding the processor to activate said speaker to output an audible audio signal.

In embodiments, the artificial fingernail processor may be in data communication with a data network via the wireless interface, and the processor may be in data communication with a remote computing device that is also in data communication with the data network, such that instructions for commanding the electronic display are able to be communicated from the remote computing device to the processor for execution by the processor.

In embodiments, the artificial fingernail processor may be in data communication with a remote computing device, such as a smart phone, via the wireless interface, such that instructions for commanding the electronic components of the invention are able to be communicated from a remote computing device to the processor for execution by the processor.

In embodiments, the artificial fingernail of the invention may be intended for use by any gender of person, and may be configured for use on the fingernails, thumb nails, and/or toenails of a user, in any number or combination.

In embodiments, a user may wear one or a plurality of artificial fingernails of the invention on one hand, or two hands, in any number and on any or all fingernails of the user. The plurality of artificial fingernails of the invention may be in wireless communication with one another, and the computer readable and executable instructions stored in the computer readable media of the artificial fingernails, or transmitted to the artificial fingernails, may provide instructions for causing the processors of the artificial fingernails to scroll text messages, or any graphic pattern or colors, across the artificial fingernails to display any scrolling or static text messages, or any graphic pattern or colors, on the artificial fingernails worn by the user.

In embodiments, the artificial fingernail may comprise an audio output element such as a microminiature speaker 1009 that is adapted to produce audio signals when commanded by the processor 1001 (see FIG. 9). For example, government alert messages may be received by the wireless interface 1002 (see FIG. 9), which may be a radio frequency wireless transceiver, whereupon the processor causes the government alert messages to be output from the speaker 1009 in the form of an audio signal that can be heard by the user, or others nearby. The artificial fingernail(s) may also be commanded by the processor 1001 to display colors, graphics, text or other visual indicators that a government alert message has been issued.

In embodiments, the electronic display(s) of the artificial fingernail(s) may be commanded to emit white or other color light to act as flashlight or emergency light sources.

In embodiments, the artificial fingernails of the invention may utilize microphone 1006 to capture and record conversations, and upload the recorded conversation to a remote server or computer 3000 via data network interface 4000 (see FIG. 9).

In embodiments, the artificial fingernails of the invention may utilize camera 1005 to record image(s) or video information, and upload the image(s) or video information to a remote server or computer 3000 via data network interface 4000 (see FIG. 9).

In embodiments, the artificial fingernails of the invention may utilize geolocation receiver 1004 (which may be, for example, a Global Positioning System or GPS receiver) to track a user's movements and upload the user's present and/or historical geographic location information to a remote server or computer 3000 via data network interface 4000 (see FIG. 9).

In embodiments, the artificial fingernails of the invention may be used to place voice phone calls via a cellular telephone system, or via an Internet Protocol (IP) system, utilizing microphone 1006 to receive voice audio from a user, transmit the voice audio to a cellular telephone system or data network via a wireless interface 1002 which may be a radio frequency wireless interface that is in communication with a cellular telephone system or data network 4000, thus transmitting audio data to a third party, and also receiving voice audio signal from the third party via the wireless interface 1002 and outputting the received audio signal from speaker 1009, such that the received audio signal may be heard and understood by a user. See FIG. 9.

In embodiments, the artificial fingernail may comprise one or more biometric sensors such as pulse oximeters for measuring blood O2 saturation levels and/or pulse rate, electrocardiogram (EKG) sensors for receiving electrocardiogram signals, and/or blood pressure sensors for receiving blood pressure information, all for receiving and capturing biometric signals and information, each of the biometric sensors 1500 in communication with the processor, and the memory may contain non-transitory computer executable instructions for commanding the one or more biometric sensors to capture such biometric signals information, and to store such biometric signals information in the memory.

In embodiments, the artificial fingernail of the invention may comprise more data sensing and reporting functionality than even the most advanced wearable mobile devices and cell phones of the prior art.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating exemplary embodiments of the invention and are not to be construed as limiting the invention.

The various features, elements and inventive concepts and principles of the invention descried, shown or claimed herein and in the accompanying drawings and claims may be present in any order, quantity or combination in the various embodiments of the invention. The relative proportions, sizes and dimensions of features shown in the figures are exemplary in nature, and are not to be considered as limitations in embodiments of the invention, i.e., the drawings are not necessarily drawn to scale.

In the drawings, like item callouts refer to like features. In the drawings:

FIG. 1 depicts a side view of an embodiment of an artificial fingernail of the invention.

FIG. 2 depicts a cross section view of an embodiment of an artificial fingernail of the invention.

FIG. 3 depicts a side view of an embodiment of an artificial fingernail of the invention being motivated on to the fingernail of a user, as a part of the process of attaching to the user's fingernail.

FIG. 4 depicts a side view of an exemplary embodiment of the invention in which the artificial nail of the invention is attached to a finger cot, providing a removable attachment of the artificial fingernail to the finger of a user.

FIG. 5 depicts a side view of an embodiment of the artificial fingernail of the invention 001 in which the electronic display 200 and base 100 are separate elements that are assembled together, showing electronic display 200 and base 100 being brought together prior to attaching them together.

FIG. 6 depicts a cross section view of an embodiment of the artificial fingernail of the invention 001 in which the electronic display 200 and base 100 are separate elements that are assembled together, showing electronic display 200 and base 100 being brought together prior to attaching them together.

FIG. 7 depicts a side view of an embodiment of the artificial fingernail of the invention 002 in which the electronic display 200 and base 100 are separate elements that are assembled together, showing electronic display 200 and base 100 assembled together.

FIG. 8 depicts an embodiment 001 of the artificial fingernail of the invention in which in which base layer 100 is manufactured integrally with an electronic display 200.

FIG. 9 depicts an exemplary embodiment of a block diagram of the electronic display 200 of the invention, showing, in schematic form, the electrically connected features and elements of electronic display 200 that enable electronic display 200 to emit light energy from its outer surface 202, or, in embodiments, 203.

FIG. 10 depicts a top view of an exemplary embodiment of a layer of the invention, and shows, in schematic form, the placement of various electrical and electronic components comprising embodiments of the artificial fingernail 001.

FIG. 11 depicts an inventive charging glove that is usable to provide electric charging current to one or more of the artificial fingernails 001 of the invention.

### DETAILED DESCRIPTION OF THE INVENTION

The following documentation provides a detailed description of the invention.

Although a detailed description as provided in this application contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

As used, herein, “artificial nails” and “artificial fingernails” includes within their meaning any device attached temporarily, removably or permanently on the finger of a user for any reason, but typically to provide a decorative appearance to the fingernail. Artificial nails may also be known as fake nails, false nails, acrylic nails, nail extensions or nail enhancements, are extensions placed over fingernails as fashion accessories. In embodiments, artificial nails may be adapted to mimic the appearance of natural fingernails as closely as possible, while others may be adapted to provide an artistic look.

As used herein, “battery” includes within its meaning any device or plurality of devices that is able to store an electric charge having a voltage potential and is adapted to communicate the voltage potential and storage energy to an electrical device or system. Batteries may comprise any materials or combinations of materials adapted for this purpose as is known, or may become known, in the art. In embodiments, batteries may comprise lithium, zinc bromide, such as, for example, electrolytes in the form of clear brine fluid, or any other materials and structures useful for storing an electric charge. “Battery” includes within its meaning, in embodiments, electric circuitry components in connection with the charge storage element for wireless magnetic induction charging of the charge storage element of the battery.

As used herein, “electronic display” includes within its meaning any electronic display capable of receiving an electrical signal comprising information for defining a desired visual display output, and, using said electrical signal comprising information for defining a desired visual display output, visually displaying said desired visual display output on a surface of the electronic display as emitted light energy. Electronic displays may comprise, for example and not by way of limitation, one or more liquid crystal Display (LCD) displays, one or more displays comprising micro light emitting diodes (LEDs and or micro LEDs), one or more displays comprising organic light emitting diodes, (OLEDs), thin film transistor liquid crystal displays (TFT display), and/or displays comprising active-matrix organic light-emitting diodes (AMOLEDs), either alone or in any combination. In embodiments the electronic display may be flexible along any axis. In embodiments the electronic display may be transparent.

As used herein, “finger” includes within its meaning fingers, thumbs and toes of a user. Thus, the artificial fingernail of the invention may be used on any number of fingers, thumbs or toes of a user, in any combination. Further, “fingernail” includes within its meaning fingernails, thumb nails and toenails. So, when reference is made to ten fingers of a user, this would mean the eight fingers and two thumbs of the user.

In embodiments of the invention, the artificial fingernail may comprise any one or more of plastic material, acrylic material, acrylic material with rubber elements, rubber material, graphite material, or any other material suitable for the intended use, in any combination or mixture. The artificial fingernail structure material may be, but is not necessarily, flexible to prevent cracking or other damage to the artificial fingernail during its use, storage and maintenance.

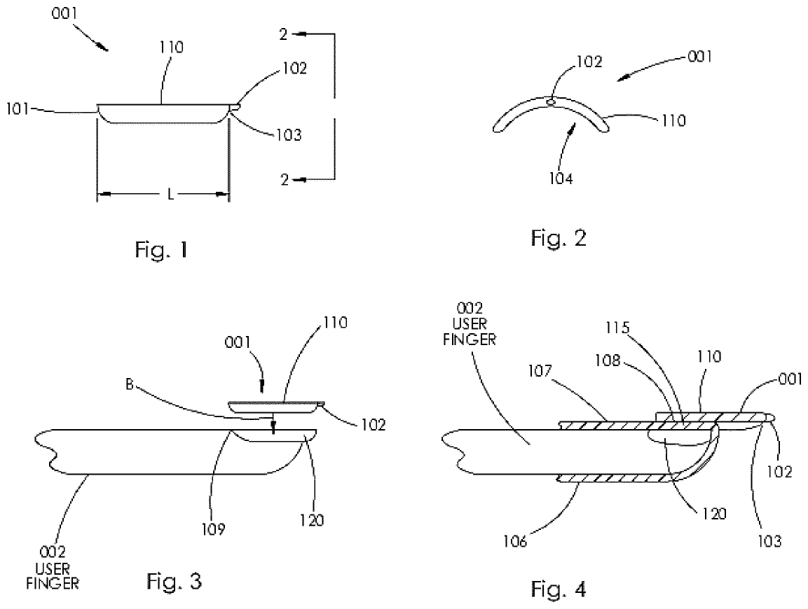

Referring now to FIGS. 1-3, an exemplary embodiment of an artificial fingernail of the invention is depicted, for purposes of describing one embodiment of the structure of the artificial fingernail of the invention. The invention 001 may comprise, among other things, a length L and a concave-shaped inner surface 104 for attaching to outer surface of a fingernail 120 of a user, or to a finger cot (such as 106 in FIG. 4). When attached to a user's fingernail 120 as depicted in FIG. 3, the length L may, but does not necessarily, extend from a cuticle apex 109 of a user to a distal tip 103 of the artificial fingernail. The artificial fingernail 001 may further comprise an optional terminal member 102 attached to the distal tip 103, such that, when the user's finger 002 is engaged in typing on, or contacting, a keyboard, touchscreen, keypad, or other input device, the terminal member 102 is the primary point of contact of the artificial fingernail 001 with the keyboard, keypad, touchscreen or other input device. Thus, in embodiments, the terminal member provides the physical contact point with the keyboard, keypad, touchscreen or other input device. Embodiments of the artificial fingernail 001 may comprise layered structure comprising materials such as one or more of rubber, graphite, or any shock absorbing material of any durometer, or any rigid material, but in exemplary non-limiting embodiments, the materials comprising the artificial fingernail structure may be of durometer in the range 30-95 Shore A hardness, inclusive. Terminal member 102 may comprise one or more of rubber, graphite, or any shock absorbing material of any durometer, but in exemplary non-limiting embodiments, of durometer in the range 30-95 Shore A hardness, inclusive. Terminal member 103 may be attached to the acritical fingernail structure by any known method such as, for example, chemical bonding, ultrasonic welding, heat welding, press fit, molding (for example, in embodiments in which terminal member 102 is molded to base 100), or any other attachment means known in the art. The artificial fingernail 001 comprises an outward-facing surface 110, which generally, but not necessarily, faces away from the user's finger 002. The artificial fingernail 001 may be attached to a fingernail 120 of a user, for example, by chemical bonding or any other means known in the relevant arts. The artificial fingernail 001 outward-facing surface 110 may be convex, as shown in FIG. 2. In embodiments, the structure of artificial fingernail 001 may be a monolithic structure, a layered structure, or any other combination of structures.

Referring now to FIG. 3, an artificial fingernail of the invention 001 may be motivated in the direction of arrow B onto, and attached to, outer surface 110 of a user's fingernail 120, where it may be attached to the fingernail of the user by, for example, chemical bonding or other means as may be known in the art. An example user's finger 002 is shown for reference.

In embodiments, terminal member 102 may comprise a stylus, for use on an electronic touch screen display or electronic keyboard that forms a part of, or is in communication with, an electronic device such as an electronic tablet, smart phone, computer touch screen display or other device. In embodiments, the stylus terminal member may be a resistive stylus. In embodiments, the stylus terminal member may be a passive capacitive stylus that may operatively interact with a touch screen by distorting the touchscreen's electrostatic field or blocking the transmission of light. Optionally, in embodiments, the stylus may be an echo stylus adapting active electrostatic technology (AES), in which the touchscreen uses an electrostatic grid, with the stylus acting as a transmitting unit generating an electrical field. The touchscreen grid may continuously register the disruption of the electrostatic field of the grid caused by the echo stylus as the echo stylus operatively interacts with the touchscreen by coming into close or physical contact with the touchscreen, therefore determining the position of the stylus on that grid, providing a location of the stylus on the touchscreen. In still further embodiments, the stylus may be an active stylus. In the active stylus embodiment, the stylus may communicate and interact with a touchscreen by a radio frequency (RF) or other communication means. One example of such RF communication means is BLUETOOTH® RF wireless technology, that may transmit and receive information one or more RF channels (frequencies). In embodiments, the stylus may be in electrical communication with a source of electric power such as a battery, which may be micro-sized, which may be wirelessly rechargeable or replaceable. Thus, the artificial fingernail of the invention may be used to interact with any touch screen that is adapted to receive input from a stylus. Thus, the artificial fingernail of the invention may be used by a use to operatively interact with an electronic touchscreen, which touchscreen may comprise a part of an electronic computing or communicating device or system such as, and not by way of limitation, a computer, a smart phone, an electronic tablet or any other electronic device. The use of the artificial fingernail of the invention enables users to decrease keystroke error rate because the stylus element may be directly aimed by the user to operatively interact with a specific point or location of a touchscreen. Further, the use of the stylus embodiments of the invention allows a user to directly operatively interact with a touch screen using up to all ten fingers of both hands, which rapidly increases typing rate, thus increasing time efficiency dramatically over the use of a stylus pen, which only has one tip and must be manually manipulated from one key entry to another on the touch screed. The invention eliminates the time needed to manually manipulate a hand-held stylus to interact operatively with the touchscreen, and also enables the use of up to all ten fingers at the same time, yielding over an order of magnitude increase in efficiency over the prior art. “Efficiency” as used in herein is a measure of the time required to input a specific amount of data in an electronic input device, such as keyboard, keypad, touchscreen or other input device. Said another way, the artificial fingernail 001 enables a user to more quickly, and more accurately, enter data into an input device.

Referring now to FIG. 4, an exemplary embodiment of the invention is depicted, in which the concave-shaped inner surface 104 of artificial nail 001 is attached to an exterior surface 107 of a finger cot 106, providing a removable attachment of the artificial fingernail 001 to the finger 002 of a user. Finger cot 106, which may comprise any material but, in embodiments, may comprise stretchable fabric, latex, nitrile, silicone, rubber, gel material, or any other material, may be attached to artificial fingernail 001 at junction 108 by any means known in the art such as, for example, chemical bonding. In embodiments artificial fingernail 001 may, but does not necessarily, comprise an optional terminal member 102 attached to distal tip 103 of artificial fingernail 001. This embodiment of the invention enables a user to enjoy the features and benefits of the artificial fingernail 001 while also allowing a removable attachment of the artificial fingernail 001 to the finger of a user 002, via the use of finger cot 106. Artificial fingernail outward facing surface 110 is depicted for reference in FIG. 4. When artificial fingernail inner surface 104 is attached to the exterior surface 107 of the finger cot 106 that is retained on the distal end of a finger 002 of the user in a compression fit, the artificial fingernail inner surface 104 may be, but is not necessarily, located opposite the fingernail of the user 120, with a wall 115 of the finger cot 106 disposed between the inner surface 104 of the artificial fingernail 001 and an outer surface of a fingernail of the user 102.

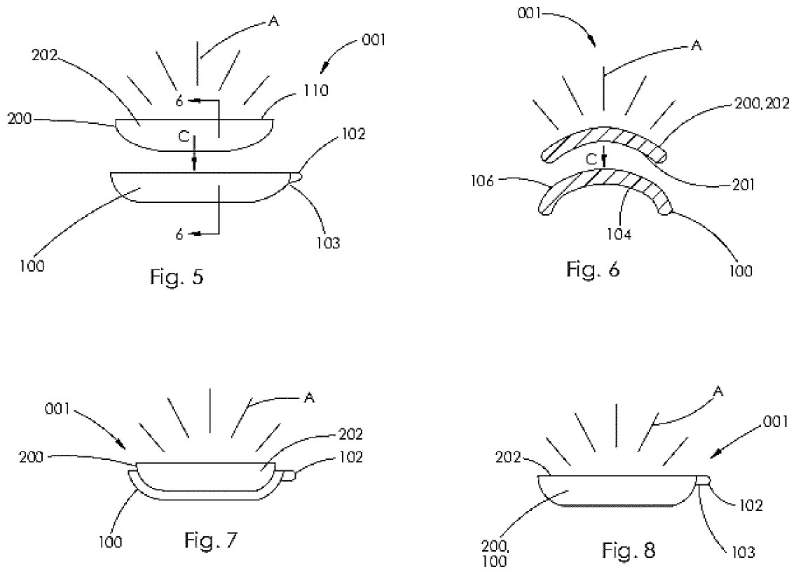

Referring now to FIGS. 5-8, embodiments of the artificial fingernail 001 are depicted in which artificial fingernail 001 comprises a layered construction, having a base layer 100 and an electronic display layer 200 for displaying any graphics, symbols, text, designs or patterns as may be desired by a user. In such embodiments, base layer 100 forms a part of the structure of artificial fingernail 001. Artificial fingernail 001 may comprise any number of layers as may be determined by the size and number of the electronic components comprising the invention, the method utilized to provide electrical interconnection between such electronic components, the number of electrical interconnects between the electronic components comprising the invention, and other factors. In other embodiments, artificial fingernail 001 may be monolithic, for example molded, and the components may be molded into the artificial fingernail 001, wherein the molded structure forms a structure of the artificial fingernail 001. Further, electronic display 200 may be, but is not necessarily, sized and shaped such that covers all or a portion of base 100. An exemplary, non-liming embodiment of this layered construction of artificial fingernail 001 in which electronic display 200 is of a size and shape that covers all of base layer 100 is depicted in FIG. 8. In embodiments comprising an electronic display 200, electronic display 200 may comprise an inner concave surface that is adapted to be complimentary with an outer surface of base layer 100, or any intervening layer between base 100 and electronic display 200. Such intervening layers may be used to form electrical interconnects between the electronic components of the artificial fingernail. The attachment between layers of the artificial fingernail may be achieved by any means known in the art for attaching layers of a structure. In embodiments, electronic display 200, and any intervening layers such as layers that comprise interconnecting conductive components or circuits, may be flexible such that they are able to be wrapped onto the outer surface of base layer 100 or any intervening layer. The number of layers is not limiting. For example, embodiments of the artificial fingernail 001 that are operable to perform a large variety of electronic functions as defined herein may require more layers than embodiments of the invention that are operable to perform fewer functions. In embodiments that comprise electronic display 200, light energy A is emitted from artificial fingernail outward facing surface 110 to provide the visual display of any graphics, in any color or combination of colors and in any pattern or other graphical scheme as desired by the user.

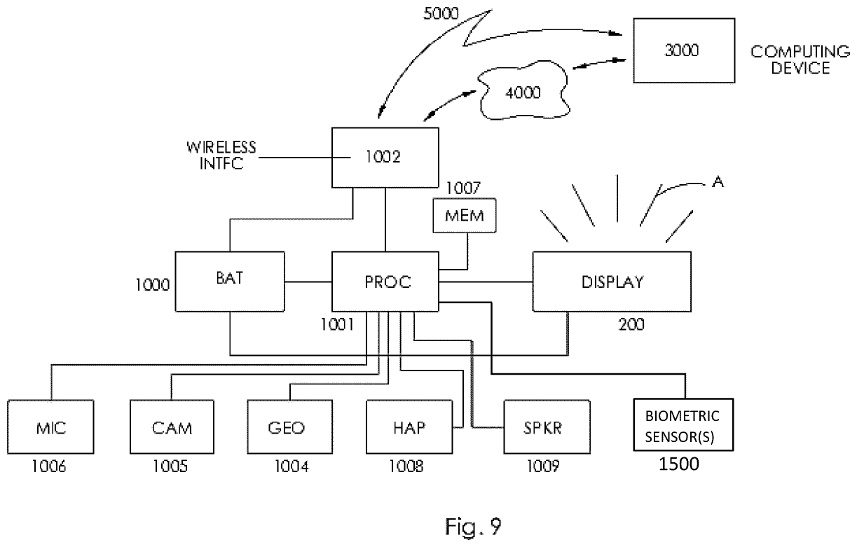

Referring now to FIGS. 5-7, an embodiment of the artificial fingernail of the invention 001 in which the electronic display 200 and base 100 are separate elements that are assembled together, is depicted. Electronic display 200 may be shaped, or may be flexible, so as to conformally fit over, and attach to, the outer surface 110 of base 100 or to any intervening layer. Electronic display 200 may have a base-facing surface 201 that is shaped to be conformal with outer surface 110 of base 100 or to any intervening layer. In an assembly step during manufacturing, electronic display 200 may be placed onto the outer surface 110 of base 100 or to any intervening layer by motivating it in the direction of arrow B, and base-facing surface 201 of electronic display 200 may be attached to outer surface 116 of base 100 or to any intervening layer by any means known in the art for permanent or removable attachment, such as, for example and not by way of limitation, by chemical bonding. In embodiments, base 100 may comprise a terminal member 102 attached to distal tip 103 of base 100. In any of the embodiments comprising an electronic display 200, electronic display 200 may comprise an outer surface 202, and electronic display 200 may comprise features and elements as described below in relation to FIG. 9 that are configured and adapted to, and operable to, emit light energy A in the form of any color or colors, graphics, symbols, text, designs or patterns, in any combination, from outer surface 202 as may be desired by a user. These are but examples of the use of the electronic display 200.

Referring now to FIG. 6, a cross section view of an exemplary embodiment of base layer 100 and electronic display 200 is shown, depicting an exemplary embodiment of the conformal fit between base-facing surface 201 of electronic display 200 and outer surface 110 of base 100, and these two surfaces being brought together along in the direction of arrow C.

Referring now to FIG. 7, an embodiment of an assembled artificial fingernail with electronic display 200 is depicted, wherein electronic display 200 has been attached to outer surface 110 of base layer 100, and light energy A is depicted emanating from outer surface 202 of electronic display 200.

Referring now to FIG. 8, an embodiment of the artificial fingernail 001 of the invention in which base layer 100 is manufactured integrally with an electronic display 200 is depicted. For example, in embodiments, electronic display 200 may be molded into base layer 100, or may be manufactured into the material of base layer 100 by any known method. The base 100/electronic display 200 combination may comprise a terminal member 102 attached to distal tip 103 of base layer 100. Base 100/electronic display 200 combination may comprise an outer surface 202 which may be an outer surface of electronic display 200. Again, electronic display 200 may comprise features and elements as described herein that are configured and adapted to, and operable to, emit light energy A in the form of any color or colors, graphics, symbols, text, designs or patterns, in any combination, from outer surface 202 as may be desired by a user.

Referring now to FIG. 9, an exemplary embodiment of a block diagram of an artificial fingernail of the invention is depicted. Electronic display 200 may emit light energy from its outer surface 202, or, in embodiments, 203. Whether comprising a part of electronic display 200 itself, or comprising one or more intervening layers, the following electronic elements may be present: a battery or other electric power or electric charge storing element 1000, which may be, but is not necessarily rechargeable, and which may be, but is not necessarily wirelessly rechargeable, may be in electrical communication with a processor or controller 1001, wireless interface 1002, which may be an RF wireless interface, an electronic display 200, and all other electrical and electronic components of the artificial fingernail. Processor 1001 may also comprise, or be in communication with, a non-transitory electronic memory 1007 that contains non-transitory computer readable and executable instructions for carrying out the features and steps of the operation and process of the invention when processed by processor 1001. Processor 1001 may also be in communication with electronic display 200. Processor 1001 may also be in communication with a wireless or other interface 1002, which may be an optical, wireless or other communication interface, which may operate as an interface to an external data network such as data network 4000 such as, for example, the Internet, via a commercial RF communication standard such as WiFi® or any other communication means. Data network 4000 may be a Local Area Network (LAN), Wireless Local Area Network (WLAN) or any other data network. Wireless interface 1002 may be in communication with a transceiver that is in direct or indirect communication with data network 4000 such as the Internet. An external computing device 3000 such as a remote server, computer, tablet, smart phone or other electronic device 3000 may also be in communication with data network 4000 via a wired or wireless connection, such that the artificial fingernail of the invention 001 is in data communication with computing device 3000 either directly via a wireless or wired data connection 5000, or indirectly via an intervening data network 4000. The artificial fingernail of the invention 001 may further comprise a geolocation receiver 1004 for receiving geolocation information, such as from satellites in a geolocation system such as GPS, GLONASS or the like; a camera 1005 for receiving and capturing photographic images or video signals or information, a microphone 1006 for receiving and capturing audio signals and information, and biometric sensors 1500 such as pulse oximeters for measuring blood O₂ saturation levels and/or pulse rate, electrocardiogram (EKG) sensors for receiving electrocardiogram signals, and/or blood pressure sensors for receiving blood pressure information, all for receiving and capturing biometric signals and information, each of the foregoing in data communication with processor 1001, and in communication with battery 1000 for receiving electrical power, such that GPS location information, photographic images, video signals and information, audio signals and information, and/or biometric information such as pulse rate, blood O₂ saturation, respiration rate, temperature, and EKG signals information may be stored in memory 1007 and/or transmitted to computing device 3000 and/or other devices via data network 4000 for further processing and display to a user via a computer monitor, screen, printer, or other output device. Still further, the artificial fingernail of the invention 001 may comprise a haptic actuator device 1008 and a speaker 1009, each in communication with processor 1001 and battery 1000. Thus, vibration (haptic) and/or audio signals and information may be output from one or more of the artificial fingernails of the invention 001 as commanded by processor 1001 to achieve any haptic or sound/audio effect such as, by way of non-limiting example, emit audio alerts from governmental authorities such as missing person, severe weather, earthquake, take shelter and other emergencies as received via wireless interface 1002 and processed by processor 1001; alert a user to an incoming telephone call or messages, and to play any desired audio signal, such as music streamed through wireless interface 1002 and processed by processor 1001. Still further, the artificial fingernails of the invention may be used to display alerts from governmental authorities such as missing person, severe weather, earthquake, take shelter and other emergencies as received via wireless interface 1002 and processed by processor 1001 on electronic displays 200. Still further, the visual display 200 may be commanded to emit light of a proper frequency to be used as a flashlight or as a safety light or an emergency beacon light, such as a flashing light. In embodiments, computing device 3000 may be a mobile electronic computing device such as a user's cell phone, which may be used by the user to command the functions and features of the artificial fingernails of the invention.

In embodiments, artificial fingernails of the invention may be placed on one, or a plurality of fingers or fingernails of the user. In case in which a user has a plurality of artificial fingernails, where each artificial fingernail is attached to a unique finger of the user, the artificial fingernails 001 may be programmed to display static words, scrolling words, colors, patterns, flashing patterns, patterns of colors, changing words or any other desired visual and/or graphic effects across the fingers of the user, in any pattern the user defines.

All of the electronic elements may be micro-miniaturized such that they may be packaged in and form a part of the artificial fingernail 001, in such a way as to visually blend into the artificial fingernail of the invention.

Still referring to FIG. 9, computing device 3000 may be used to provide information to, and receive information from, the artificial fingernail of the invention, and to provide instructions to the artificial fingernail to be carried out by processor 1001. For example, instructions may be transmitted from computing device 3000 to processor 1001, causing processor 1001 to command each, some, or all of the artificial fingernail elements to:
Display one or more colors, images, patterns, symbols, shapes, photographic images, designs, in any combination or composition;
Brighten or dim the light output A from the electronic display 200 of each artificial fingernail to establish any desired visual effect on any artificial fingernail;
Change light output intensity of each artificial fingernail based on time of day or night;
Turn any particular artificial fingernail “off” (no light emission) or “on” (at least some light emission);
Change colors, images, patterns, light output intensity, over time in any desired sequence or combination to create desired visual effect on the fingers of a user;
wherein each individual artificial fingernail is individually programmable;
capture audio or video information;
measure biometric data and/or provide biometric feedback to a user; or
perform any function for which the elements of artificial fingernail are capable of performing, alone or in combination with other elements of the artificial fingernail.

In embodiments, instructions may be transmitted from computing device 3000 to processor 1001, causing processor 1001 to command each, some, or all of the artificial fingernails of the invention to display information that is usable to train the user in the use of musical instruments such as piano, or guitar.

In general, computing systems and/or devices, such as processor 1001 and computing device 3000, may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, micro-processors, micro-controllers, a computer work-station, a server computer, a desktop computer, notebook computer, laptop computer, or handheld computer, or some other computing system and/or device comprising a processor in communication with a medium for storing computer readable and executable instructions for carrying out the method and/or process steps of the invention.

Computing devices generally include non-transitory computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium such as memory 1007 (also referred to as a processor-readable medium) includes any non-transitory (e.g., tangible) medium that participates in providing data (e.g., instructions) that may be read by a computer, processor or controller such as processor 1001 or computer device 3000 (e.g., by a processor of a computer). Memory 1007 may comprise the non-transitory computer readable and executable instructions that are used by the processor 1001 to command the electrical and electronic components of the invention to carry out the functions of the artificial fingernail. Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer or wirelessly. Common forms of computer-readable media include, for example, solid state memory, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above and are accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, the software that causes processor 1001 to carry out the functions and steps of the invention may be implemented as computer-readable instructions (e.g., software) on one or more computing devices (e.g., servers, personal computers, etc.), stored on non-transitory computer readable media associated therewith (e.g., disks, memories, etc.). A computer program product may comprise such instructions stored on computer readable media such as non-transitory computer readable memory 1007 for carrying out the functions described herein.

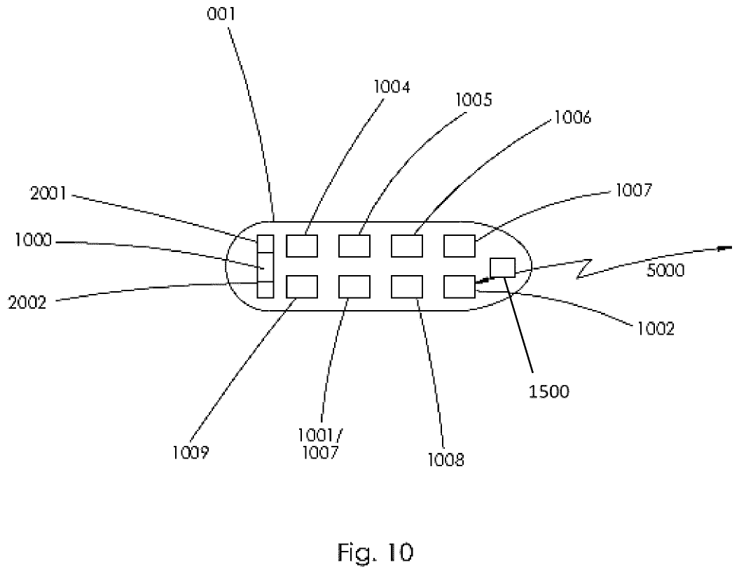

Referring now to FIG. 10, an embodiment of a layer, which may be a base or intervening layer, of the artificial fingernail 001 is depicted, as an example of but one of many embodiments of the invention. In the embodiments depicted, electrical and electronic components processor 1001, memory 1007, wireless transceiver interface 1002, geolocation receiver 1004, camera 1005, microphone 1006, battery 1000 and biometric sensors(s) 1500 may be physically attached to one or more layers, and may be interconnected electrically with one another, and with the electronic display 200, by any number of electrically interconnecting material layers having electrically conductive traces, or by wired electrical connections such as printed conductive traces or wire bonding, in any combination thereof. Thus, in embodiments, artificial fingernail may have a multi-layered structure, with as many layers as may be required to provide the required electrical interconnections between the electrical and electronic components of the artificial fingernail. Conductive electrical terminals 2001 and 2002 may also be present for electrically charging battery 1000 or powering the electrical components when needed, such as, for example, during testing of the artificial fingernail electronic functions. It should be noted that while, for the embodiment depicted, all the described functions may be shown, it is not necessary that all the electrical and electronic components, features and and functions be present in all embodiments of the invention.

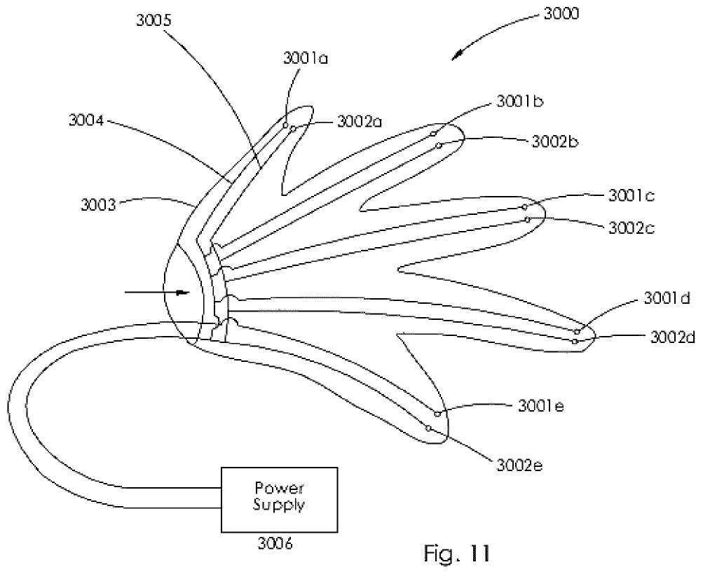

Referring now to FIG. 11, an embodiment of a charging glove 3003 is depicted. The charging glove is useful to charge battery 1000, or a plurality of same, by the user wearing the glove and causing the electrical contact points 3001a, 3002a, 3001b, 3002b, 3001c, 3002c, 3001d, 3002d, 3001e and 3002e to come into electrically conductive contact with electrical terminals 2001 and 2002 on artificial fingernails 001 of a user. Each of the glove electrical contacts 3001a, 3002a, 3001b, 3002b, 2003a, 3003b, 3004a, 3004b, 3005a and 3005b are in electrical communication with a source of electric charging current 3006 via conductors 3004 and 3005 as shown in FIG. 11. When the user puts on the charging glove 3003, the above electrical connections are made, providing an electrical charging current to each artificial fingernail of the user, effectively charging battery 1000 in each of the artificial fingernails 001 of the user. While the embodiment of the charging glove 3003 depicted in FIG. 11 shows five fingers in the charging glove, in embodiments, the charging glove may comprise one, two, three, four, five or any number of fingers.

Any of the instructions transmitted from computing device 3000 to processor 1001 may be stored as non-transitory computer readable and executable instructions in memory 1007 for recall and later use by the processor 1001.

In embodiments, instructions may be transmitted from computing device 3000 to processor 1001, causing processor 1001 to command each, some, or all of the artificial fingernails of the invention to perform the functions and features described here, and, as the functions and features are exemplary in nature, all equivalent functions and features are within the scope of the claim invention as well.

The described features and elements of the invention may be present in the various embodiments of the invention in any combination, quantity or order.

What is claimed is:

1. An artificial fingernail, comprising:
a structure adapted to be attached to the fingernail of a user, said structure comprising:
a concave shaped inner surface for attaching to said fingernail, or to a finger cot; and
a length extending from an apex of the base to a distal tip of the structure;
said artificial fingernail further comprising a terminal member attached to the distal tip, said terminal member disposed on said distal tip, and extending beyond said distal tip, such that, when the user's finger is engaged in typing on a keyboard, keypad, or touchscreen, the terminal member is the primary point of contact of the artificial fingernail with the keyboard, keypad or touchscreen.

2. The artificial fingernail of claim 1, wherein said structure comprises one or more of the following materials: plastic, acrylic, graphite, and rubber.

3. The artificial fingernail of claim 1, wherein said terminal tip comprises a compressible material.

4. The artificial fingernail of claim 1, wherein said terminal tip comprises a stylus for interacting with an electronic touch screen.

5. The artificial fingernail of claim 4, wherein said stylus is of a type selected from one of the following types: a passive stylus, a resistive stylus, a passive capacitive stylus, an echo stylus, and an active stylus.

6. An artificial fingernail, comprising:
a structure adapted to be attached to the fingernail of a user, said structure comprising:
a concave shaped inner surface for attaching to said fingernail;
a length extending from an apex of the base to a distal tip of the structure; and
a processor and memory, wherein said processor and said memory are in data communication, and wherein said memory comprises non-transitory computer readable and executable instructions for operatively communicating with one or more user input/output electronic components comprising said artificial fingernail.

7. The artificial fingernail of claim 6, wherein said one or more user input/output electronic components is defined as an electronic display.

8. The artificial fingernail of claim 7, wherein operatively communicating is further defined as commanding the electronic display to emit light energy in a desired image, pattern, or color, or combination of image, pattern, or color as commanded by said processor.

9. The artificial fingernail of claim 6, wherein said one or more user input/output electronic components is defined as a geolocation receiver.

10. The artificial fingernail of claim 9, wherein operatively communicating is further defined as reading geolocation information from said geolocation receiver and storing said geolocation information in said memory.

11. The artificial fingernail of claim 6, wherein said one or more user input/output electronic components is defined as a microphone.

12. The artificial fingernail of claim 11, wherein operatively communicating is further defined as receiving audio information from said microphone and storing said audio information in said memory.

13. The artificial fingernail of claim 6, wherein said one or more user input/output electronic components is defined as a camera.

14. The artificial fingernail of claim 13, wherein operatively communicating is further defined as commanding said processor to read photographic image information, video information, or both from said camera and storing said photographic image information, video information, or both in said memory.

15. The artificial fingernail of claim 6, wherein said one or more user input/output electronic components is defined as a haptic device.

16. The artificial fingernail of claim 15, wherein operatively communicating is further defined as commanding said haptic device to output mechanical vibration energy.

17. The artificial fingernail of claim 6, wherein said one or more user input/output electronic components is defined as a speaker.

18. The artificial fingernail of claim 17, wherein operatively communicating is further defined as commanding said speaker to output an audible audio signal.

19. The artificial fingernail of claim 6, further comprising a battery in communication with said processor, said memory, and said one or more user input/output electronic components.

20. The artificial fingernail of claim 19, wherein said battery is chargeable via a wireless magnetic inductive connection, or via electrically conductive connection.

21. The artificial fingernail of claim 6, further comprising a wireless data communication interface in communication with said processor, and wherein said memory comprises computer executable instructions for commanding the wireless data communication interface to be in data communication with a remote computing device via said wireless interface.

22. The artificial fingernail of claim 21, wherein said data communication is via an external data network.

23. The artificial fingernail of claim 6, further comprising terminal member attached to the distal tip, said terminal member disposed on said distal tip, and extending beyond said distal tip, such that, when the user's finger is engaged in typing on a keyboard, keypad, or touchscreen, the terminal member is the primary point of contact of the artificial fingernail with the keyboard, keypad or touchscreen.

24. The artificial fingernail of claim 6, wherein said structure comprises one or more of the following materials: plastic, acrylic, graphite, and rubber.

25. The artificial fingernail of claim 6, wherein said terminal tip comprises a compressible material.

26. The artificial fingernail of claim 6, wherein said terminal tip comprises a stylus for interacting with an electronic touch screen.

27. The artificial fingernail of claim 26, wherein said stylus is of a type selected from one of the following types: a passive stylus, a resistive stylus, a passive capacitive stylus, an echo stylus, and an active stylus.

28. The artificial fingernail of claim 6, where said one or more user input/output electronic components is further defined as one or more of 1) an electronic display; 2) a geolocation receiver; 3) a microphone; 4) a camera; 5) a haptic actuator; and 6) a speaker, in any combination.

29. The artificial fingernail of claim 6, further comprising at least one biometric sensor in communication with said processor.

30. A wearable artificial fingernail, comprising:
an artificial fingernail, said artificial fingernail comprising an inner surface adapted to be attached to an exterior surface of a finger cot;
wherein, when said artificial fingernail inner surface is attached to the exterior surface of said finger cot that is retained on the distal end of a finger of the user in a compression fit, the artificial fingernail inner surface is located opposite the fingernail of the user, with a wall of the finger cot disposed between the inner surface of the artificial fingernail and the outer surface of a fingernail of the user;
said artificial fingernail further comprising a terminal member attached to the distal tip, said terminal member disposed on said distal tip, and extending beyond said distal tip, such that, when the user's finger is used for typing on a keyboard, keypad, or touchscreen, the terminal member is the primary point of contact of the artificial fingernail with the keyboard, keypad or touchscreen.

31. A wearable artificial fingernail, comprising:
an artificial fingernail, said artificial fingernail comprising an inner surface adapted to be attached to an exterior surface of a finger cot;
wherein, when said artificial fingernail is attached to the exterior surface of said finger cot that is retained on the distal end of a finger of the user in a compression fit, said artificial fingernail is located opposite the fingernail of the user, with a wall of the finger cot disposed between the concave shaped inner surface of the base and the outer surface of a fingernail of the user;
said artificial fingernail further comprising a processor and memory, wherein said processor is in data communication with said memory, and wherein said memory comprises non-transitory computer readable and executable instructions for operatively communicating with one or more user input/output electronic components comprising said artificial fingernail.

32. The artificial fingernail of claim 31, wherein said one or more user input/output electronic components is defined as an electronic display.

33. The artificial fingernail of claim 32, wherein operatively communicating is further defined as commanding the electronic display to emit light energy in a desired image, pattern, or color, or combination of image, pattern, or color as commanded by said processor.

34. The artificial fingernail of claim 31, wherein said one or more user input/output electronic components is defined as a geolocation receiver.

35. The artificial fingernail of claim 34, wherein operatively communicating is further defined as reading geolocation information from said geolocation receiver and storing said geolocation information in said memory.

36. The artificial fingernail of claim 31, wherein said one or more user input/output electronic components is defined as a microphone.

37. The artificial fingernail of claim 36, wherein operatively communicating is further defined as receiving audio information from said microphone and storing said audio information in said memory.

38. The artificial fingernail of claim 31, wherein said one or more user input/output electronic components is defined as a camera.

39. The artificial fingernail of claim 38, wherein operatively communicating is further defined as commanding said processor to read photographic image information, video information, or both from said camera and storing said photographic image information, video information, or both in said memory.

40. The artificial fingernail of claim 31, wherein said one or more user input/output electronic components is defined as a haptic device.

41. The artificial fingernail of claim 40, wherein operatively communicating is further defined as commanding said haptic device to output mechanical vibration energy.

42. The artificial fingernail of claim 31, wherein said one or more user input/output electronic components is defined as a speaker.

43. The artificial fingernail of claim 42, wherein operatively communicating is further defined as commanding said speaker to output an audible audio signal.

44. The artificial fingernail of claim 31, further comprising a battery in communication with said processor, said memory, and said one or more user input/output electronic components.

45. The artificial fingernail of claim 44, wherein said battery is chargeable via a wireless magnetic inductive connection, or via electrically conductive connection.

46. The artificial fingernail of claim 31, further comprising a wireless data communication interface in communication with said processor, and wherein said memory comprises computer executable instructions for commanding the wireless data communication interface to be in data communication with a remote computing device via said wireless interface.

47. The artificial fingernail of claim 46, wherein said data communication is via an external data network.

48. The artificial fingernail of claim 31, further comprising at least one biometric sensor in communication with said processor.

49. The artificial fingernail of claim 31, further comprising terminal member attached to the distal tip, said terminal member disposed on said distal tip, and extending beyond said distal tip, such that, when the user's finger is engaged in typing on a keyboard, keypad, or touchscreen, the terminal member is the primary point of contact of the artificial fingernail with the keyboard, keypad or touchscreen.

50. The artificial fingernail of claim 49, wherein said base comprises one or more of the following materials: plastic, acrylic, graphite, and rubber.

51. The artificial fingernail of claim 49, wherein said terminal tip comprises a compressible material.

52. The artificial fingernail of claim 49, wherein said terminal tip comprises a stylus for interacting with an electronic touch screen.

53. The artificial fingernail of claim 52, wherein said stylus is of a type selected from one of the following types: a passive stylus, a resistive stylus, a passive capacitive stylus, an echo stylus, and an active stylus.

54. The artificial fingernail of claim 31, where said one or more user input/output electronic components is further defined as one or more of 1) an electronic display; 2) a geolocation receiver; 3) a microphone; 4) a camera; 5) a haptic actuator; 6) a speaker, in any combination.
